(19) United States
(12) Patent Application Publication
(10) Pub. No.: US 2005/0177471 A1
(43) Pub. Date: Aug. 11, 2005

(54) Joint venture accounting method and system

(76) Inventors: Timothy James Crossett, St. Leon-Rot (DE); Fred Buessecker, Waghaeusel (DE); Armin Risch, Hockenheim (DE)

Correspondence Address: KENYON & KENYON, 1 BROADWAY, NEW YORK, NY, 10004, US

(21) Appl. No.: 10/743,724

(22) Filed: Dec. 24, 2003

(51) Int. Cl. G06F 17/60

(52) U.S. Cl. 705/30

(57) ABSTRACT

Embodiments of the present invention relate to software for adjusting the accounting records of a business venture to reflect a new allocation of shares in the venture among a plurality of entities.

### FIELD OF THE INVENTION

Embodiments of the present invention relate to a method and system for adjusting the accounts of a business venture to reflect a new allocation of shares in the venture among a plurality of entities.

### BACKGROUND INFORMATION

In the upstream oil and gas industry, many companies enter into joint operating agreements. In a joint operating agreement (JOA), the risks, costs and rewards of a business venture may be shared among a plurality of entities, such as companies acting as partners in the venture. Any one company may participate in a large number (e.g., several hundred) of joint ventures whose terms are governed by one or more respective JOAs. A JOA may, among other things, specify who/which are the partners in a venture, and the proportions of an allocation of shares in a venture among them. The proportions may, for example, be specified in terms of percentages: e.g., 50 percent to partner A, 25 percent to partner B, and 25 percent to partner C. Such a specification of proportions of share allocation may be termed an “equity share assignment.”

According to one typical kind of JOA, one company may be the majority shareholder in a venture, and one or more other companies may be minority shareholders. The majority shareholder may be responsible for running the venture (and thus be known as the “venture operator”), while a minority shareholder is a passive investor, simply contributing to the costs of the venture activity but also sharing in the revenues generated (in such a situation, a minority shareholder may also be known as a “non-operating venture partner”). The venture operator may be responsible for, among other things, maintaining the accounting books for the venture, collecting money to fund the venture activity, accounting for total production, revenues and costs of the venture and splitting these among the non-operating venture partners according to their share percentages as specified by the equity share assignment, and for reporting on the venture to the non-operating venture partners.

Typically for the upstream oil and gas industry, the partners in a joint venture and their respective share percentages in the venture may change over time (e.g., new partners join and/or old partners leave, resulting in a re-proportioning of share allocation according to an amended JOA and a corresponding new equity share assignment). Such changes may entail time-consuming legal arrangements. This means that often the accounting department of the venture operator may be informed of a new equity share assignment well after, for example a period of months, the new equity share assignment has taken effect. Thus, accounting records for the venture may reflect proportions according to a previous equity share assignment for a period of time that was actually covered by an amended JOA and a corresponding new equity share assignment. Accordingly, the venture operator needs to be able to correspondingly adjust the accounting records, not only going forward from the time its accounting department was informed of the new equity share assignment, but for any earlier period(s) covered by the amended JOA. An amended JOA might even, for example, be retroactive to the inception of a venture.

Known accounting software has disadvantages with respect to making adjustments for changes according to an amended JOA as described above. For example, the known accounting software lacks flexibility with respect to which time periods and for which accounting records such adjustments may be applied. Further, the known software does not provide for making adjustments to cash call accounting records.

### SUMMARY OF THE INVENTION

Embodiments of the present invention relate to software for adjusting the accounting records of a business venture to reflect a new allocation of shares in the venture among a plurality of entities. In contrast to known software, software according to embodiments of the present invention provides for selectably specifying a time period for which adjustments should be applied, where the time period may extend from a present time as far back as a time of an inception of a venture, and for selectably specifying accounting records to which the adjustments should be applied. Furthermore, in contrast to known software, software according embodiments of the present invention handles adjustments to cash call accounting records.

### BRIEF DESCRIPTION OF THE DRAWINGS

FIG. 1 shows an example of a series of accounting records created in various accounts of a business venture according to embodiments of the present invention;

FIG. 2 shows a process flow according to embodiments of the present invention; and

FIG. 3 shows an example of a computer system for implementing embodiments of the present invention.

### DETAILED DESCRIPTION

Embodiments of the present invention relate to computer-executable instructions for flexibly updating accounting records of a business venture to reflect a change in an allocation of shares in the venture among a plurality of entities. For example, the entities may be partners in the venture. Processes executable by the instructions may comprise:
(a) providing a user interface enabling the selection of a time period for which adjustments to the accounting records are to be applied, where the time period may extend from a present time as far back as a time of an inception of a joint venture, or be any period therebetween;
(b) providing a user interface enabling the selection of one or more types of accounting records to which the adjustments are to be applied, where the accounting records may include cash call accounting records; and
(c) based on inputs received via the user interface, applying adjustments to the accounting records of the joint venture.

Adjustments to accounting records pursuant to a selection made according to (b) may include performing a process to adjust accounting records in a ledger for a joint venture (hereinafter, “JV ledger”) according to a new equity share assignment. The new equity share assignment could specify changed proportions in share allocation among a pre-existing group of partners, or specify proportions of share allocation among a new group of partners (e.g., more or fewer partners than in the pre-existing group). The JV ledger may comprise accounting records for several general accounts of a legal entity (e.g., a company), including: revenues, expenses, partner accounts receivable, partner accounts payable, control and reconciliation accounts, and bank accounts. Operations of the process for adjusting accounting records in the JV ledger may comprise:
(1) creating reversing accounting records to reverse existing accounting records in the JV ledger according to a previous equity share assignment;
(2) creating in the JV ledger, for the new equity share assignment, accounting records with amounts corresponding to the existing accounting records reversed by (1). More specifically, a given equity share assignment may have associated therewith descriptive information such as a unique equity share assignment identifier, unique account numbers, and the like. The formation of a new equity share assignment may entail the creation of new accounting records with contents distinct from contents of records of a previous equity share assignment, with unique descriptive information associated therewith to distinguish the accounting records of the new equity share assignment from those of the previous equity share assignment. Thus, the accounting records created in (2) may have associated therewith, for example, a new equity share assignment identifier, new account numbers, and other information associated with the new equity share assignment;
(3) creating, in partner accounts in the JV ledger, reversing accounting records corresponding to the accounting records created in (1), with amounts in proportions according to the previous equity share assignment; and
(4) creating, in the partner accounts in the JV ledger, accounting records corresponding to the accounting records created in (2), with amounts in proportions according to the new equity share assignment.

If there is an inter-company partner associated with the joint venture, operations according to (b) may comprise:
(5) creating, in an inter-company ledger of the joint venture, reversing accounting records corresponding to the accounting records created in (1), with amounts in proportions according to the previous equity share assignment; and
(6) creating, in the inter-company ledger of the joint venture, accounting records corresponding to the accounting records created in (2), with amounts in proportions according to the new equity share assignment.

Adjustments to accounting records pursuant to selections made according to (b) may further include performing a process to adjust cash call records of partner accounts in the JV ledger according to the new equity share assignment. This process may comprise:
(7) creating reversing cash call accounting records to reverse existing cash call accounting records made to the partner accounts in the JV ledger according to a previous equity share assignment;
(8) creating cash call accounting records corresponding to the existing records reversed by (7) in the partner accounts of the JV ledger for the new equity share assignment, but recording amounts in the same proportions as in the previous equity share assignment;
(9) optionally performing a cash call correction process to create accounting records indicating, in the partner accounts of the JV ledger for the new equity share assignment, a difference corresponding to cash calls between the previous equity share assignment and the new equity share assignment; and
(10) optionally performing a cash call correction process to create accounting records indicating, in the inter-company ledger for the new equity share assignment, a difference corresponding to cash calls between the previous equity share assignment and the new equity share assignment.

Adjustments to accounting records pursuant to a selection made according to (b) may further include (11) optionally performing a “cutback correction” process that comprises creating reversing accounting records to reverse the accounting records created in the inter-company ledger in (6), above.

An example will now be given of a process for adjusting the accounting records of a business venture to reflect a change in an allocation of shares in the venture. The example will trace the creation of accounting records pursuant to a first equity share assignment and the subsequent adjustment of the records pursuant to a different equity share assignment replacing the first. While the example involves only two partners, the operations illustrated may be applied for a joint venture having any number of partners.

Assume that a JOA exists for a group of entities consisting of partner A, an inter-company partner (a fictional entity maintained for accounting purposes), and partner B. The JOA defines an equity share assignment in a venture to partners A and B. The equity share assignment allocates proportions of shares wherein partner A has a 70% share of the venture and is the operating partner. Partner B has a 30% share of the venture and is a non-operating partner. Assume that the equity share assignment is identified as “EG1.”

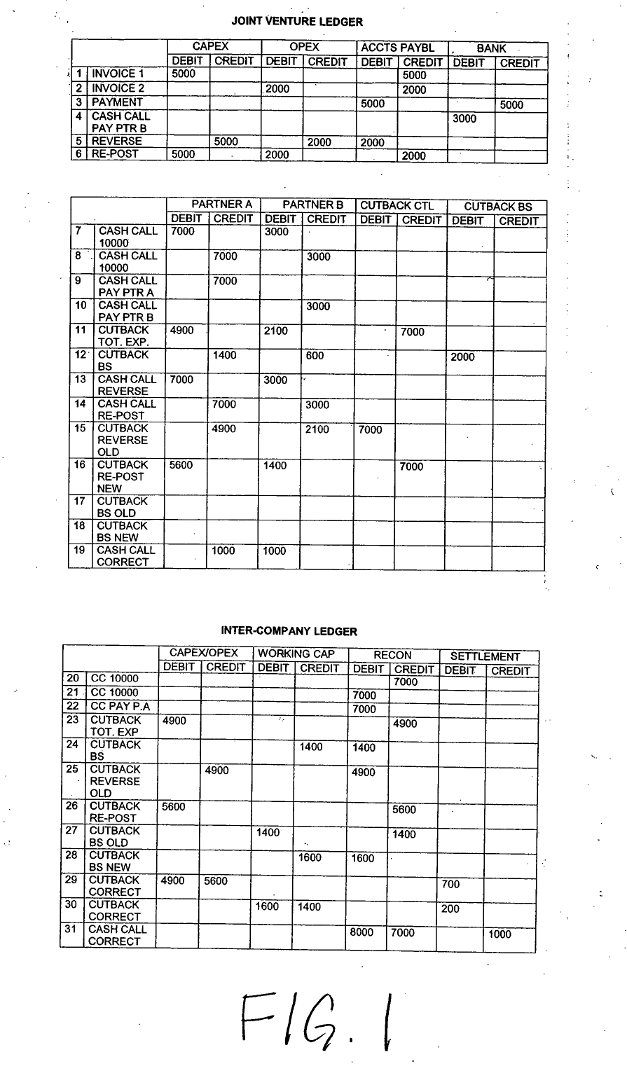

FIG. 1 traces the creation of accounting records during a period while it is assumed that equity share assignment EG1 is in effect, and ensuing adjustments after it is learned that instead, EG2, an equity share assignment different from EG1, was in effect for the period. Assume FIG. 1 shows application of the well-known invoice-based method of accounting. FIG. 1 shows various accounts within a JV ledger. The JV ledger may include such accounts as capital expenses (CAPEX), operating expenses (OPEX), an accounts payable account, a company bank account, individual partner (here, partner A and partner B) accounts payable and accounts receivable accounts, a cutback control account and a cutback balance sheet (BS) account.

An inter-company ledger for the joint venture is further illustrated in FIG. 1. The inter-company ledger may include accounts similar to those of the JV ledger, above, reflecting activities of the venture as a whole, such as a CAPEX/OPEX account, a working capital account, a reconciliation account, and a settlement account. The inter-company ledger's entries reflect the 70% share (initially) of partner A as the operating partner.

Some business activities pursuant to the venture corresponding to terms assumed to be controlled by EG1 may take place, and the venture's accounting records may be correspondingly updated. For example, the operating partner may receive invoices for products/services provided. Referring to FIG. 1, assume the operating partner (partner A) receives an invoice for $5000 and an invoice for $2000 (hereinafter, the “$” is omitted from amounts discussed). The invoice for 5000 represents a capital cost and the invoice for 2000 represents an operating cost. According to standard accounting practice, the invoice amounts may be reflected as new accounting entries in the JV ledger as shown in FIG. 1: 5000 (line 1) as a debit to the CAPEX account and 2000 (line 2) as a debit to the OPEX account. Further, each of the invoice amounts may be posted as a credit to the accounts payable account (lines 1 and 2).

Operating partner A may then pay 100% of the first invoice amount; this may be recorded as a debit of 5000 (line 3) to the accounts payable account, and a 5000 credit (line 3) to the bank account.

Now, assume that the venture requires funds to support the venture activity (which is usually cost and capital intensive). One way the operating partner might get the funds is by creating a “cash call”; a cash call is like an advance payment request to each partner or partners in a venture. Assume the operating partner creates a cash call of 10,000. According to standard accounting practice, the cash call would be recorded in respective accounts of the partners in the JV ledger according to the proportions called for by the equity share assignment currently assumed to be in effect, here, EG1. Thus, as shown in FIG. 1, 70% (7000) (line 7) of the cash call would be recorded as a debit in partner A's account and 30% (3000) (line 7) of the cash call would be recorded as a debit in partner B's account. Additionally, each of the cash call amounts would be recorded (line 8) as a credit to the corresponding partner's account, representing the amounts recoverable by each partner against future costs incurred in the venture. Offsetting credit and debit entries for partner A's 70% of the cash call may also be made in the inter-company ledger reconciliation account (FIG. 1, lines 20 and 21).

Now assume that partner A and partner B each pays its share of the cash call. According to standard accounting practice, this would be recorded as a credit in each partner's respective account in the JV ledger (FIG. 1, lines 9 and 10). The inter-company ledger reconciliation account would receive an offsetting debit for partner A (line 22), and the bank account would receive a debit (line 4) corresponding to partner B's payment.

A periodic “cutback” process may then occur. “Cutback” refers to distributing expenses and revenues of a venture to partners according to the proportions required by the equity share assignment currently in effect. Cutback may be performed monthly, for example. As a result of the cutback process, amounts may be entered as new accounting records to the JV ledger as shown in FIG. 1. That is, of the 7000 in total costs (recalling the venture costs for 5000 and 2000 described above), 70% or 4900 is entered on partner A's account as a debit (line 11), and 30% or 2100 is entered on partner B's account as a debit (line 11). An offsetting entry of 7000 is entered on the cutback control account (line 11). Accounting entries for 4900, representing partner A's 70% share, are made respectively to the inter-company ledger CAPEX/OPEX account as a debit (line 23) and to the inter-company ledger reconciliation account as a credit (line 23).

Also as a result of the cutback process, balance sheet totals may be distributed to partners according to the proportions required by the equity share assignment currently in effect. Thus, 70% or 1400 of balance sheet total 2000 is entered in the JV ledger as a credit to partner A's account (line 12), and 30% or 600 as a credit to partner B's account (line 12). An offsetting entry of 2000 is entered in the cutback balance sheet account (line 12). In the inter-company ledger, partner A's 70% share is recorded as a credit of 1400 in the working capital account (line 24), with an offsetting debit entry in the reconciliation account (line 24).

Now assume that the venture company's accounting department is informed of a new equity share assignment, EG2, due to an amendment of the JOA, that became effective a month previously. The new equity share assignment is still held by partners A and B, but the proportions allocated by the new equity share assignment are, respectively, 80% to partner A and 20% to partner B. Thus, the accounting records must be adjusted to reflect the new allocation, not only henceforward, but for the previous month (which includes all of the accounting records discussed above).

Computer-executable instructions according to embodiments of the present invention may be executed to perform the needed adjustments. The instructions may generate a user interface comprising a plurality of displays containing fields allowing for user input. Based on user input, a time period or periods for which adjustments are to be applied may be selected. The time period may extend from a present time as far back as a time of an inception of a venture, or may be any period of time therebetween. Moreover, one or more types of accounting records to which the adjustments should be applied, where the accounting records may include cash call accounting records, may be selected. For the selected time period(s) and records, instructions according to embodiments of the present invention may be executed to automatically perform adjustments.

Referring to the example under discussion, assume that the preceding month is defined as the period for adjustment. Further, assume that a selection is made to adjust JV ledger records according the new equity share assignment, EG2. As noted earlier, this process may comprise (1) creating reversing accounting records to reverse existing accounting records in the JV ledger according to the previous equity share assignment, EG1. This is indicated in FIG. 1 by a credit of 5000 to the CAPEX account (line 5), a credit of 2000 to the OPEX account (line 5), and a debit of 2000 to the accounts payable account (line 5).

The process may further comprise (2) creating in the JV ledger, for the new equity share assignment EG2, accounting records with amounts corresponding to the existing accounting records reversed by (1). This is indicated in line 6 of FIG. 1 by a debit of 5000 to the CAPEX account, a debit of 2000 to the OPEX account, and a credit of 2000 to the accounts payable account, all of which may have associated therewith, for example, the new equity share assignment identifier EG2, new account numbers, and other information associated with the new equity share assignment (not illustrated in FIG. 1 to avoid cluttering the figure).

The process may, as noted above, further comprise (3) creating, in partner accounts in the JV ledger, reversing accounting records corresponding to the accounting records created in (1), with amounts in proportions according to the previous equity share assignment. Put another way, the postings of (1) are cutback to partner accounts according to the proportions of the previous equity share assignment. Cutback operations to partner accounts according to the proportions of the previous equity share assignment are indicated in FIG. 1 in the JV ledger on line 15 by a credit of 4900 to partner A's account, a credit of 2100 to partner B's account, and a debit of 7000 to the cutback control account. This effectively nullifies the original cutback accounting records according to the previous equity share assignment, indicated in FIG. 1 on line 11.

The process may further comprise (4) creating, in the partner accounts in the JV ledger, accounting records corresponding to the accounting records created in (2), in proportions according to the new equity share assignment. Put another way, the postings of (2) are cutback to partner accounts according to the proportions of the new equity share assignment. Cutback operations to partner accounts according to the proportions of the new equity share assignment are indicated on line 16 by a debit of 5600 (80% of total expenses of 7000) to partner A's account, a debit of 1400 (20% of total expenses of 7000) to partner B's account, and a credit of 7000 to the cutback control account.

Cutback operations to partner accounts according to the proportions of the previous equity share assignment corresponding to the balance sheet amount of 2000 are indicated in FIG. 1 on line 17 by a debit of 1400 to partner A's account, a debit of 600 to partner B's account, and a credit of 2000 to the cutback balance sheet account. Cutback operations to partner accounts according to the proportions of the new equity share assignment corresponding to the balance sheet amount of 2000 are indicated in FIG. 1 on line 18 by a credit of 1600 in partner A's account (corresponding to partner A's new 80% share), a credit of 400 in partner B's account (corresponding to partner B's new 20% share), and a debit of 2000 in the cutback balance sheet account.

As noted above in (5), if there is an inter-company partner as in the present example, operations may further comprise creating, in an inter-company ledger of the joint venture, reversing accounting records corresponding to the accounting records created in (1), with amounts in proportions according to the previous equity share assignment. Put another way, the postings of (1) are cutback to inter-company accounts according to the proportions of the previous equity share assignment. Cutback operations to the inter-company accounts according to the proportions of the previous equity share assignment are indicated in FIG. 1 on line 25 by a credit of 4900 to the CAPEX/OPEX account and a debit of 4900 to the reconciliation account.

As noted in (6), operations may further comprise creating, in the inter-company ledger of the joint venture, accounting records corresponding to the accounting records created in (2), with amounts in proportions according to the new equity share assignment. Put another way, the postings of (2) are cutback to inter-company accounts according to the proportions of the new equity share assignment. Cutback operations to inter-company accounts according to the proportions of the new equity share assignment corresponding to the total expense of 7000 are indicated in FIG. 1 on line 26 by a debit of 5600 (partner A's new 80% share) in the CAPEX/OPEX account and a credit of 5600 in the reconciliation account.

Cutback operations to inter-company accounts according to the proportions of the previous equity share assignment corresponding to the balance sheet amount of 2000 is indicated in FIG. 1 on line 27 by a debit of 1400 to the working capital account and a credit of 1400 to the reconciliation account. Cutback operations to inter-company accounts according to the proportions of the new equity share assignment corresponding to the balance sheet amount of 2000 are indicated in FIG. 1 on line 28 by a credit of 1600 (partner A's new 80% share) in the working capital account and a debit of 1600 in the reconciliation account.

Now assume that a selection is made to adjust cash call records of the partner accounts in the ledger for a joint venture according the new equity share assignment, EG2. As noted earlier, this process may comprise (7) creating reversing cash call accounting records to reverse existing cash call accounting records made to the partner accounts in the JV ledger according to the previous equity share assignment, EG1. This is indicated in FIG. 1 on line 13 by a debit of 7000 to partner A's account and a debit of 3000 to partner B's account.

The process may, as noted above, further comprise (8) creating cash call accounting records corresponding to the existing records reversed by (7) in the partner accounts of the JV ledger for the new equity share assignment, EG2, but recording amounts in the same proportions as in the previous equity share assignment. This is indicated on line 14 by a credit of 7000 to partner A's account and a credit of 3000 to partner B's account. These accounting records may have associated therewith the new equity share assignment identifier EG2, new account numbers, and other information associated with the new equity share assignment (not illustrated).

As further noted earlier, a cash call correction process (9) may optionally be performed to create accounting records indicating, in the partner accounts of the JV ledger for the new equity share assignment, a difference corresponding to cash calls between the previous equity share assignment the new equity share assignment. In the present example, the difference is 10% (a 70/30 allocation changed to an 80/20 allocation). Therefore, a corrective accounting record for 1000 (10% of the 10,000 cash call) is created in the partner accounts receivable accounts, as shown on line 19 by a credit of 1000 to partner A's account and a debit of 1000 to partner B's account.

As noted in (10), a cash call correction process may optionally be performed to create accounting records indicating, in the inter-company ledger for the new equity share assignment, a difference corresponding to cash calls between the previous equity share assignment and the new equity share assignment. This is indicated on line 31 by a debit of 8000 and a credit of 7000 to the reconciliation account, and a credit of 1000 to the settlement account.

As further noted earlier, adjustments to accounting records may further include (11) optionally performing a “cutback correction” process that comprises creating reversing accounting records to reverse the accounting records created in the inter-company ledger in (6). This option may be useful, for example, in situations in which a venture does not wish to show a new share allocation. This may be the case, for example, in an operator-as-partner situation, where a non-operating partner farms out part of his/her share to another company, where the other company holds a share in the non-operating partner's share. The cutback correction process is illustrated in FIG. 1 on line 29 by creating reversing accounting postings of 4900 and 5600 to the debit and credit sides, respectively, of the CAPEX/OPEX inter-company account, and on line 30 by creating reversing accounting postings of 1600 and 1400 to the debit and credit sides, respectively, of the working capital inter-company account. Postings of a debit of 700 (line 29) and a debit of 200 (line 30) are also made to the settlement account.

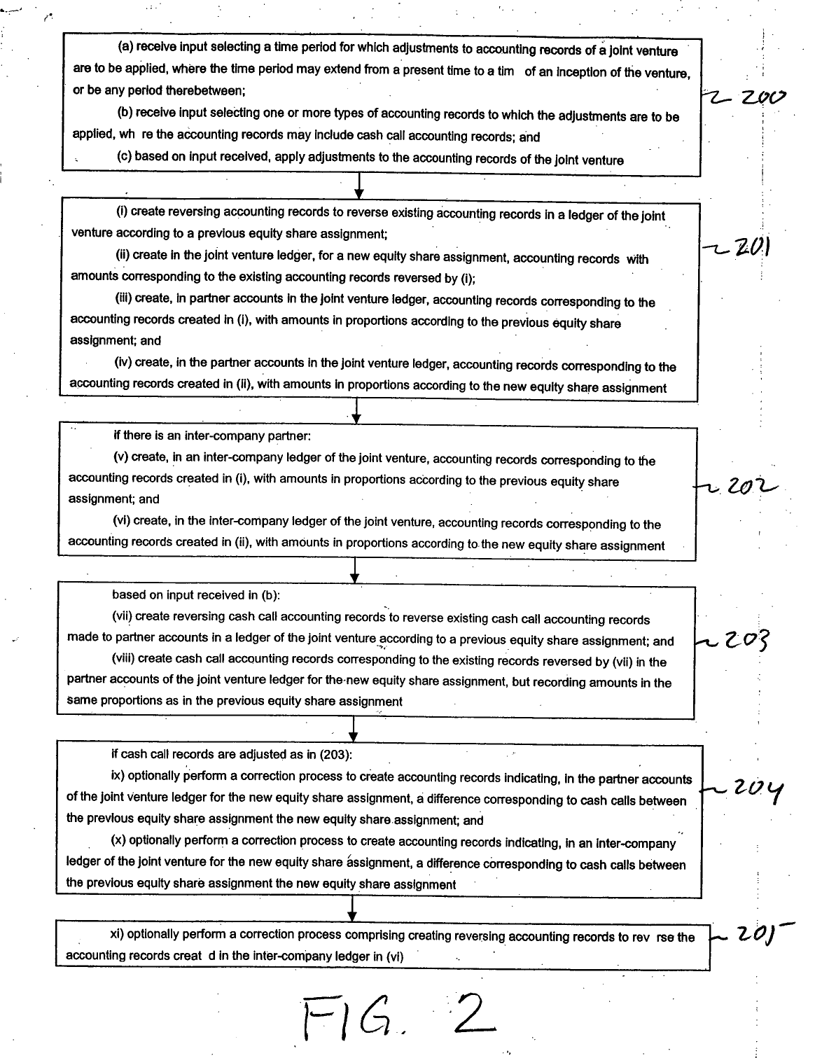

FIG. 2 shows a process flow according to embodiments of the present invention. As shown in block 200, the process may comprise:
(a) receiving input selecting a time period for which adjustments to accounting records of a joint venture are to be applied, where the time period may extend from a present time to a time of an inception of the venture, or be any period therebetween;
(b) receiving input selecting one or more types of accounting records to which the adjustments are to be applied, where the accounting records may include cash call accounting records; and
(c) based on input received, applying adjustments to the accounting records of the joint venture.

As shown in block 201, based on input received in (b), the process may further comprise:
(i) creating reversing accounting records to reverse existing accounting records in a ledger of the joint venture according to a previous equity share assignment;
(ii) creating in the joint venture ledger, for a new equity share assignment, accounting records with amounts corresponding to the existing accounting records reversed by (i);
(iii) creating, in partner accounts in the joint venture ledger, accounting records corresponding to the accounting records created in (i), with amounts in proportions according to the previous equity share assignment; and
(iv) creating, in the partner accounts in the joint venture ledger, accounting records corresponding to the accounting records created in (ii), with amounts in proportions according to the new equity share assignment.

As shown in block 202, if there is an inter-company partner associated with the joint venture, the process may further comprise:
(v) creating, in an inter-company ledger of the joint venture, accounting records corresponding to the accounting records created in (i), with amounts in proportions according to the previous equity share assignment; and
(vi) creating, in the inter-company ledger of the joint venture, accounting records corresponding to the accounting records created in (ii), with amounts in proportions according to the new equity share assignment.

As shown in block 203, based on input received in (b), the process may further comprise:
(vii) creating reversing cash call accounting records to reverse existing cash call accounting records made to partner accounts in a ledger of the joint venture according to a previous equity share assignment; and
(viii) creating cash call accounting records corresponding to the existing records reversed by (vii) in the partner accounts of the joint venture ledger for the new equity share assignment, but recording amounts in the same proportions as in the previous equity share assignment.

As shown in block 204, if cash call records are adjusted as in block 203, the process may further comprise:
(ix) optionally performing a correction process to create accounting records indicating, in the partner accounts of the joint venture ledger for the new equity share assignment, a difference corresponding to cash calls between the previous equity share assignment the new equity share assignment; and
(x) optionally performing a correction process to create accounting records indicating, in an inter-company ledger of the joint venture for the new equity share assignment, a difference corresponding to cash calls between the previous equity share assignment the new equity share assignment.

As shown in block 205, the process may further comprise:
(xi) optionally performing a correction process comprising creating reversing accounting records to reverse the accounting records created in the inter-company ledger in (vi).

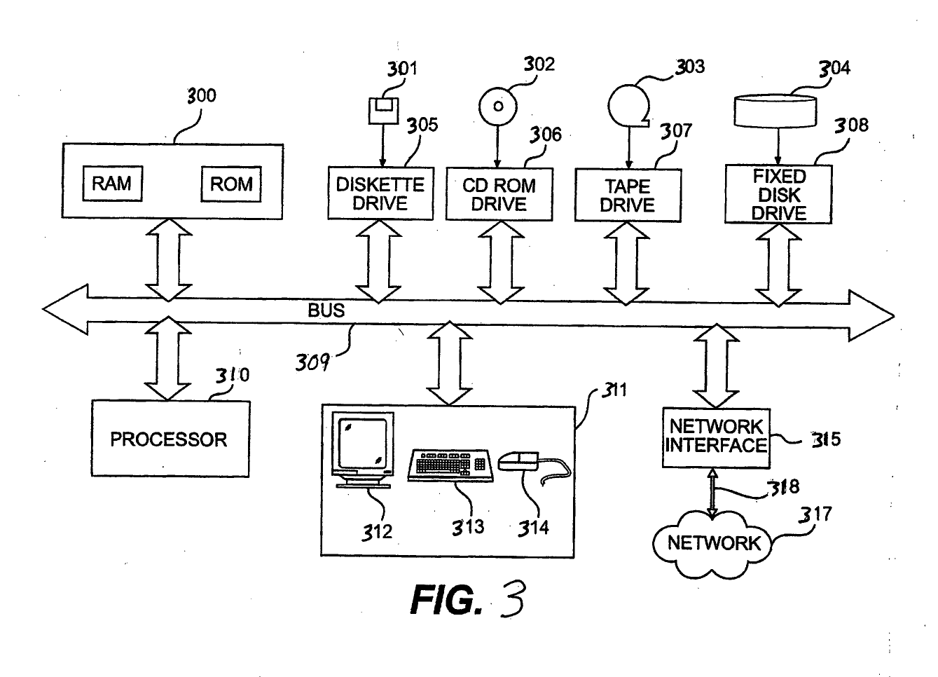

FIG. 3 shows a high-level representation of a computer system for implementing embodiments of the present invention, such as might be realized by a variety of known and commercially available hardware and software elements. The system may comprise a memory 300 including ROM and RAM, processor 310 and user interface 311 comprising a display device 312, keyboard 313 and mouse 314. Elements may communicate via a system bus 309. The system may further comprise a network 317 connected by a network medium 318 and network interface 315.

A computer program or collection of programs comprising computer-executable instructions according to embodiments of the present invention may be stored and transported on computer-usable media such as diskette 301, CD-ROM 302, magnetic tape 303 and fixed disk 304. The computer instructions may be retrieved from the computer-usable media 301-304 using their respective drives 305-308 into memory 300, and executed by a processor 310. The functionality disclosed hereinabove for performing the embodiments may find specific implementations in a variety of forms, which are considered to be within the abilities of a programmer of ordinary skill in the art after having reviewed the specification.

Several embodiments of the present invention are specifically illustrated and/or described herein. However, it will be appreciated that modifications and variations of the present invention are covered by the above teachings and within the purview of the appended claims without departing from the spirit and intended scope of the invention.

1. An automated method comprising:
(a) receiving input selecting a time period for which adjustments to accounting records of a joint venture are to be applied, where the time period may extend from a present time to a time of an inception of the venture, or be any period therebetween;
(b) receiving input selecting one or more types of accounting records to which the adjustments are to be applied, where the accounting records may include cash call accounting records; and
(c) based on input received, applying adjustments to the accounting records of the joint venture.

2. The automated method of claim 1, further comprising, based on input received in (b):
(i) creating reversing accounting records to reverse existing accounting records in a ledger of the joint venture according to a previous equity share assignment;
(ii) creating in the joint venture ledger, for a new equity share assignment, accounting records with amounts corresponding to the existing accounting records reversed by (i);
(iii) creating, in partner accounts in the joint venture ledger, accounting records corresponding to the accounting records created in (i), with amounts in proportions according to the previous equity share assignment; and
(iv) creating, in the partner accounts in the joint venture ledger, accounting records corresponding to the accounting records created in (ii), with amounts in proportions according to the new equity share assignment.

3. The automated method of claim 2, further comprising, if there is an inter-company partner associated with the joint venture:
(v) creating, in an inter-company ledger of the joint venture, accounting records corresponding to the accounting records created in (i), with amounts in proportions according to the previous equity share assignment; and
(vi) creating, in the inter-company ledger of the joint venture, accounting records corresponding to the accounting records created in (ii), with amounts in proportions according to the new equity share assignment.

4. The automated method of claim 1, further comprising, based on input received in (b):
(vii) creating reversing cash call accounting records to reverse existing cash call accounting records made to partner accounts in a ledger of the joint venture according to a previous equity share assignment; and
(viii) creating cash call accounting records corresponding to the existing records reversed by (vii) in the partner accounts of the joint venture ledger for the new equity share assignment, but recording amounts in the same proportions as in the previous equity share assignment.

5. The automated method of claim 4, further comprising:
(ix) optionally performing a correction process to create accounting records indicating, in the partner accounts of the joint venture ledger for the new equity share assignment, a difference corresponding to cash calls between the previous equity share assignment the new equity share assignment.

6. The automated method of claim 4, further comprising:
(x) optionally performing a correction process to create accounting records indicating, in an inter-company ledger of the joint venture for the new equity share assignment, a difference corresponding to cash calls between the previous equity share assignment the new equity share assignment.

7. The automated method of claim 3, further comprising:
(xi) optionally performing a correction process comprising creating reversing accounting records to reverse the accounting records created in the inter-company ledger in (vi).

8. A machine-readable medium storing computer-executable instructions to implement a process comprising:
(a) receiving input selecting a time period for which adjustments to accounting records of a joint venture are to be applied, where the time period may extend from a present time to a time of an inception of the venture, or be any period therebetween;
(b) receiving input selecting one or more types of accounting records to which the adjustments are to be applied, where the accounting records may include cash call accounting records; and
(c) based on input received, applying adjustments to the accounting records of the joint venture.

9. The machine-readable medium of claim 8, the process further comprising, based on input received in (b):
(i) creating reversing accounting records to reverse existing accounting records in a ledger of the joint venture according to a previous equity share assignment;
(ii) creating in the joint venture ledger, for a new equity share assignment, accounting records with amounts corresponding to the existing accounting records reversed by (i);
(iii) creating, in partner accounts in the joint venture ledger, accounting records corresponding to the accounting records created in (i), with amounts in proportions according to the previous equity share assignment; and
(iv) creating, in the partner accounts in the joint venture ledger, accounting records corresponding to the accounting records created in (ii), with amounts in proportions according to the new equity share assignment.

10. The machine-readable medium of claim 9, the process further comprising, if there is an inter-company partner associated with the joint venture:
(v) creating, in an inter-company ledger of the joint venture, accounting records corresponding to the accounting records created in (i), with amounts in proportions according to the previous equity share assignment; and
(vi) creating, in the inter-company ledger of the joint venture, accounting records corresponding to the accounting records created in (ii), with amounts in proportions according to the new equity share assignment.

11. The machine-readable medium of claim 8, the process further comprising, based on input received in (b):
(vii) creating reversing cash call accounting records to reverse existing cash call accounting records made to partner accounts in a ledger of the joint venture according to a previous equity share assignment; and
(viii) creating cash call accounting records corresponding to the existing records reversed by (vii) in the partner accounts of the joint venture ledger for the new equity share assignment, but recording amounts in the same proportions as in the previous equity share assignment.

12. The machine-readable medium of claim 11, further comprising:
(ix) optionally performing a correction process to create accounting records indicating, in the partner accounts of the joint venture ledger for the new equity share assignment, a difference corresponding to cash calls between the previous equity share assignment the new equity share assignment.

13. The machine-readable medium of claim 11, further comprising:
(x) optionally performing a correction process to create accounting records indicating, in an inter-company ledger of the joint venture for the new equity share assignment, a difference corresponding to cash calls between the previous equity share assignment the new equity share assignment.

14. The machine-readable medium of claim 10, further comprising:
(xi) optionally performing a correction process comprising creating reversing accounting records to reverse the accounting records created in the inter-company ledger in (vi).
